(19) United States
(12) Patent Application Publication
(10) Pub. No.: US 2008/0178811 A1
(43) Pub. Date: Jul. 31, 2008

(54) Construction and method for treating and in particular for milking an animal

(76) Inventor: Holger Heinrich, Ennigerloh (DE)

Correspondence Address: SMITH LAW OFFICE, 440 SCIENCE DR., SUITE 302, MADISON, WI, 53711, US

(21) Appl. No.: 11/977,064

(22) Filed: Oct. 23, 2007

(30) Foreign Application Priority Data
Oct. 27, 2006 (DE) 10 2006 051 362.2

(51) Int. Cl. A01J 5/00; A01J 7/00

(52) U.S. Cl. 119/14.04; 119/14.18

(57) ABSTRACT

A construction and a method for treating animals, in particular for milking lactating animals, with a milking module or a milking place and with a standing area for the animal to be treated and at least one opening in the standing area through which at least one treatment device can be passed. There is provided a pivotable milking module with at least two functional components, supported to be rotatable around a hinge pin disposed beneath the standing area, at least one functional component comprising at least one treatment device. The treatment device can be moved automatically, by way of a pivoting movement about the hinge pin of the milking module disposed beneath the standing area, from a rest position disposed beneath the standing area to a presentation position disposed at least in part above the standing area.

### FIELD AND BACKGROUND OF THE INVENTION

The present invention relates to a construction and a method for treating and in particular for milking animals such as cows, sheep, goats, buffaloes, llamas, camels, dromedaries, yaks, elks, horses and the like.

The invention may be applied e.g. in machine-milking of animals. Application is in particular possible in milking parlors where treating and/or milking the teats occurs semi-automatically.

Different constructions and methods for milking animals have become known in the prior art. What is used at present is as a rule, teat cups according to a two-chamber principle where a central teat chamber is surrounded by a pulse chamber. The central teat chamber is connected with a milk line and is vacuumized to a specific level. In the pulse chamber a pulsating pressure curve, the so-called pulsation, is generated by means of a pulsator. For this purpose, two different pressure sources are periodically applied to the pulse chamber, one subpressure source and another pressure source which is often at atmospheric pressure but may also be pressurized or at a slight subpressure. The pulsation achieves periodic opening and closing of the liner inside the teat cup and thus a stimulation of the milk flow. At present, milking is as a rule performed mechanically in that a teat cup is placed on the teat of the animal to be milked and thereafter the milk is extracted mechanically.

There also exist fully automatic systems which, apart from milking, also perform the placing of the teat cups fully automatically.

A fully automatic milking system has become known from DE 36 50 637 T2 in which placing of the milking cluster on the udder occurs automatically. The milking cluster is placed from beneath through the floor of the standing area. A large-structured carrier holds the milking unit and bowl-shaped basin for cleaning the udder, both of which are situated above the milking parlor floor when in place and which are received to be rotatable 180° around a hinge pin positioned above the milking parlor floor. A cylinder conveys the carrier with the milking unit by way of a linear movement from beneath and upwardly through the platform. The system comprises multiple components above the platform which in the case of nervous animals thrashing about are in serious danger of being damaged. The drawback of such a structure is that the individual components exposed to an animal need to be very robust to lastingly withstand the possible loads, in particular taking into account the considerable weight of cows which can be up to 600 kg or even more.

Although fully automatic systems offer the farmer the advantage that his presence is no longer required during the entire milking operation, many such systems do not involve any time-saving since a number of checking and maintenance measures need to be performed.

One advantage of conventional, mechanical milking systems with manual placing is that the farmer is in direct contact with his animals on a regular basis such that he can automatically see and thus recognize udder disorders or other illnesses in individual animals, such as e.g. foot diseases etc. in the routine of morning and evening milking. This is an advantage that automatic milking systems do not offer.

Although both automatic and conventional milking systems use an increasing number of different sensors to indicate possible illness in the animals, reliable results tend to require extensive chemical testing, often involving expensive reactants.

Another drawback is the difficulty of finding suitable criteria of distinction between healthy and sick animals, such that fully automatic systems tend to trigger the alarm more often than necessary.

In conventional machine-milking the animal is often directly within sight of the farmer in the case of a sensor alarm so as to eliminate in conventional systems the additional time often required in fully automatic systems for examining the animal. These are some of the reasons why the working time reduction in fully automatic systems is smaller than originally expected.

### SUMMARY OF THE INVENTION

It is therefore the object of the present invention to provide a system so as to facilitate the work process while allowing the farmer to remain in contact with the animals.

Preferred specific embodiments of the invention are the subjects of the corresponding subclaims.

The milking place according to the invention serves for treating animals and in particular for milking animals, comprising a standing area for the animal to be treated and at least one opening in the standing area through which at least one treatment device can be passed. There is provided a pivotable milking module which is rotatably supported around a hinge pin disposed beneath the standing area and which has at least two functional components, at least one of said functional components comprising at least one treatment device. The treatment device of the functional component can be moved automatically, by way of a pivoting movement about the hinge pin of the milking module disposed beneath the standing area, from a rest position disposed beneath the standing area to a presentation position disposed at least in part above the standing area.

The invention has many advantages. It is a considerable advantage that the milking module with the at least two functional components is pivotable about a hinge pin disposed beneath the standing area. This is space-saving, offering considerable advantages since in the rest position the treatment device is protected from all influence, being disposed beneath the standing area, while in the presentation position it is provided in the immediate vicinity of the udder.

The hinge pin disposed beneath the standing area or the milking parlor floor achieves reliable protection of the components in the case that the animal to be milked should become restless or start kicking. Moreover, functioning is simplified since all the positions can be reached by way of a pivoting movement.

By way of the pivoting movement the treatment device is available for application in the presentation position in the vicinity of the animal such that the time and force which the operator or the farmer must apply for treating and milking the animal is reduced. Efficiency as a whole increases such that a larger number of animals per unit of time can be treated. At the same time the operator has more time to examine the entire animal and to recognize any disease present in the animal. This results in better herd control and correspondingly in better health of the herd.

Another advantage is that the lines leading to the treatment device are directly passed from beneath so that they do not obstruct the vision. Also, no supporting arms are required which would limit the freedom of movement or obstruct the vision.

Another advantage is that a stripping function can readily be incorporated in that tension is applied on the milk hoses from beneath.

The presentation position may be designated as the passing position since in the presentation position the treatment device is passed to the operator for the operator to directly grasp the treatment device and bring it to the animal. The presentation position may thus also be referred to as a ready position since the treatment device is ready for treatment there.

In particular a first pivoting movement of the milking module into a first pivoting position will bring a first functional component into an active position in which a second functional component is in an inactive position, and a second pivoting movement into a second pivoting position can bring the second functional component into an active position in which the first functional component is in an inactive position.

Preferably the second pivoting position succeeds the first pivoting position. Preferably a third pivoting position succeeding the second pivoting position is provided, in particular if three functional components are disposed. It is particularly preferred for the milking module of the milking place according to the invention to comprise three or four functional components, and in particular one functional component with a teat cleaning device or with teat cups for cleaning or foremilking, one functional component with teat cups for milking, and one functional component with a treatment device for post-treatment. A fourth functional component may serve as a cover for the opening.

The milking module according to the invention for treating animals and in particular for milking animals is supported to be rotatable about a hinge pin which, if properly installed, is disposed at a milking place beneath the standing area of the milking place. The milking module has at least two functional components disposed on it with at least one functional component comprising at least one treatment device for treating animals. The treatment device can be moved automatically from a rest position into a presentation position by way of a pivoting movement of the milking module. The milking module may comprise part of the standing area.

The method for treating animals and in particular for milking animals according to the invention provides for an animal to be positioned on a standing area, and at least one treatment device is passed through an opening in the standing area from beneath. By way of pivoting a milking module having multiple functional components about a hinge pin disposed beneath a standing area of a milking place, the treatment device is automatically moved from a rest position into a presentation position.

In the presentation position the treatment device can be grasped by an operator and manually moved to the udder or the teats of the animal to be treated.

Preferred specific embodiments of the invention provide for at least one teat cup as a treatment device. Preferably the milking place or the device for milking or the milking module comprises two or four treatment units of a treatment device configured as teat cups. Other treatment devices may comprise one or more treatment units each.

In another preferred specific embodiment at least one cleaning device is provided as the treatment device. The udder of the animal to be treated can be cleaned with this. It is also possible to provide a cleaning device only for cleaning of a teat or the teats.

At least one foremilking cup can be provided as a treatment device. Furthermore at least one teat care device can be provided as a treatment device. A teat care device may serve to apply a treatment preparation on the teat of an animal. Said device may be employed as a pre-dipping device or as a post-dipping device.

Preferably at least one treatment device is taken from the group of the treatment devices indicated above.

In preferred specific embodiments of all the configurations of the invention described above at least one treatment device with two or four identical treatment units is provided which may in particular be configured as teat treatment device or teat cups.

Furthermore, a number of different treatment devices are preferably provided. It is thus preferred to provide, other than teat cups also teat cleaning devices and/or foremilking devices and/or dipping devices. It is preferred to provide different functional components with different treatment devices.

In particular at least two different functional components and thus at least two different treatment devices can be brought one by one into the presentation position where pre-positioning takes place.

This allows a simple way of treating the animals since the required devices are immediately pre-positioned or passed and the operator is only required to attach the corresponding devices.

In a preferred specific embodiment the milking module is configured as a revolver with functional components that can be pivoted one by one into the presentation position.

In all the configurations the presentation position is preferably provided near the edge of the milker pit such that the milker can comfortably grasp the passed treatment devices with his arms bent. In this position he can grasp the treatment devices configured e.g. as teat cups with little exertion and in a combined forwardly and upwardly movement place them on the teats of the animal. If, however, the treatment devices are positioned at such a distance that the milker must grasp the treatment devices with his arms outstretched, he will tire more easily since the strain is inconvenient.

Removing the treatment device and in particular the teat cups at the end of the milking operation preferably occurs at high speed so as to avoid any contact of the teat cups with the milking parlor floor which may be dirty.

The fact that the milking unit and the other devices are passed from beneath, additionally allows a better view of the udder of the animal and the animal itself so as to result in a close monitoring of animal health. When incorporated sensors emit a warning signal, the operator can directly visually inspect the animal without having to firstly study a computer-generated list, go to the shed and then examine the animal concerned. This allows the farmer to save the time required therefor. Since the routine is enhanced at the same time, the entire throughput can noticeably be increased further.

In particularly preferred specific embodiments of the invention at least one milking module for treating animals and in particular for milking animals is provided, on which at least two functional components are provided at least one of which functional components comprising at least one treatment device for treating animals, wherein the treatment device can be automatically moved by means of a pivoting movement of the milking module from a rest position into a presentation position. One functional component can receive at least two different treatment devices.

The milking module is in particular disposed to be movable. The pivotable milking module can additionally be configured to be transversable and in particular linearly transversable. For example, the milking module may be transversable as a whole from a rest-into a base position, from where the individual functional components or the treatment devices can be pivoted into the presentation positions. This means that by way of pivoting, a treatment device is passed through the standing area from beneath.

Preferably multiple different treatment devices are disposed at the functional components of the milking module.

In preferred configurations a first pivoting for example can transfer a functional component with a cleaning device into the presentation position and a second pivoting can transfer a functional component with the teat cups into the presentation position. Other rotating or pivoting movements are conceivable such that one or multiple foremilking cups, dipping devices etc. can be transferred into the presentation position or into the presentation positions.

A functional component preferably serves as a cover or a lid on the opening in the standing area of the milking parlor floor. By way of pivoting the functional component into the closed position, a plane milking parlor floor is provided so as to minimize the risk of injuries.

It is also possible that by way of a pivoting movement of the milking module different functional components with corresponding treatment devices can be brought into a base position beneath the standing area. Then, another rotational movement of the milking module can bring the corresponding treatment devices from the base position into the presentation position. Each of the movements occurs in particular automatically.

In all of the configurations the milking module is transversable at least between a rest- and an operating position. In the rest position the entire milking module is in particular protected from external influences.

All of the configurations provide for the treatment devices to be brought manually from the presentation position to the teats of the animal to be treated.

In a specific embodiment of the invention a machine-stripping device is provided by means of which a force acting downwardly can be applied on at least one teat cup in particular through the associated milk hose. In this way one can achieve efficient milking-out and prevent the teat cups from creeping up the teats.

The machine-stripping device is in particular suitable for applying an individual force on each teat to allow individual milking-out of the teats. This results in a particularly efficient and gentle milking.

In specific embodiments of the invention a rinsing adapter is preferably provided to rinse and/or clean and/or disinfect at least one functional component or at least one treatment device. Preferably the treatment device can be brought to the rinsing adapter automatically. The rinsing or cleaning process may be performed after each animal or after a specific number of animals or at specified times or as needed. The hygiene is thus enhanced.

There can in particular be provided a rinsing device for cleaning the or individual functional components of the milking module which are configured e.g. as spray nozzles for spraying the entire milking module e.g. during rotational movements.

In preferred specific embodiments of the invention the opening in the standing area can be automatically covered or closed to reduce the entry of dirt and to prevent injuries.

In all specific embodiments, two, three, four or more openings may be provided, the individual openings being configured e.g. elongated or round. The width of the openings in the standing area is in particular smaller than 10 cm and preferably smaller than 8 cm and particularly preferred smaller still.

The precise dimensions of the openings in the standing area depend on the dimensions of the treatment device to be passed through. The teat cups for ewes or goats are as a rule smaller than for milking devices for milking cows, such that in the case of milking devices for milking ewes the openings may be configured smaller.

In all of the configurations a milk collection piece may be provided to receive the milk from two or four teats collectively. Separate discharging for each teat is also conceivable.

Specific embodiments of the invention provide for the animals to be positioned on the standing area of the milking place so as to position the udder of the animals to be milked in a desired range. Corresponding sensors may be provided for this purpose. It is also conceivable to fixate each animal individually to ensure the smoothest operation possible.

Further features, characteristics and advantages of the present invention can be taken from the following description of the embodiments with reference to the attached drawings.

### BRIEF DESCRIPTION OF THE DRAWINGS

FIG. 1 a milking place according to the invention in a sectional side view with a milking module according to the invention in a first position;

FIG. 2 the milking place of FIG. 1 in a sectional side view with the milking module in a second position;

FIG. 3 the milking place of FIG. 1 in a sectional side view with the milking module in a third position;

FIG. 4 a milking place with another milking module according to the invention in a closed position;

FIG. 5 the milking place of FIG. 4 in pivoting movement;

FIG. 6 the milking place of FIG. 4 in the presentation position;

FIG. 7 a modified floor cover lid for a milking parlor according to FIG. 1;

FIG. 8 another floor cover lid for a modification of the milking parlor according to FIG. 1; and

FIG. 9 a third variant of a floor cover lid for a modification of the milking parlor according to FIG. 1.

### DETAILED DESCRIPTION OF THE PREFERRED EMBODIMENTS

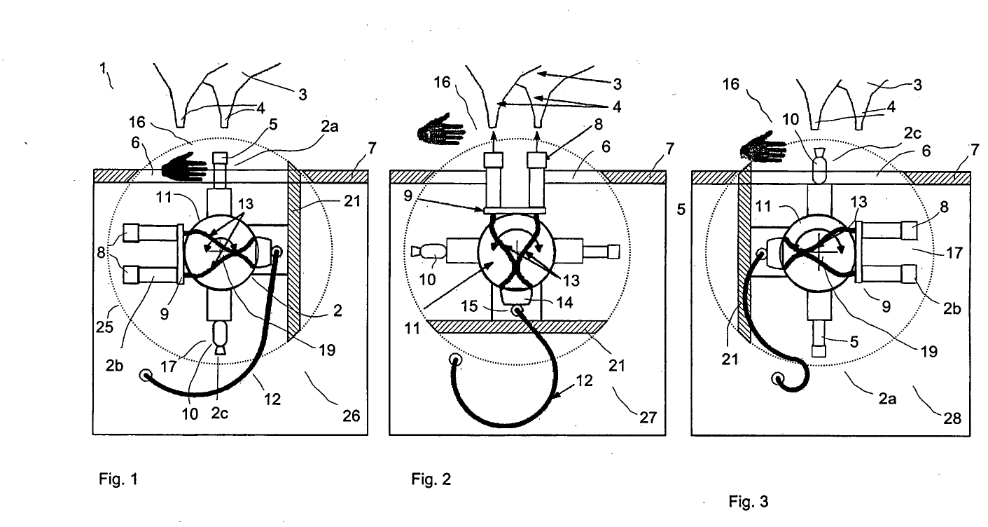

Referring to the attached FIGS. 1 to 3, a first embodiment of the invention for application in the milking of cows will now be described. With suitable modifications the invention may be applied for milking animals having e.g. two teats.

FIG. 1 illustrates a milking place 1 according to the invention in a sectional side view and in a first pivoting position 26. The milking place 1 comprises a standing area 7 provided with openings 6 for the different treatment devices to be passed through the platform from beneath.

The device for milking furthermore comprises a milking module 2, which is presently configured as a rotatably supported revolving device 11 and functional components 2a, 2b, and 2c for cleaning and/or foremilking (2a), for milking (2b), and for post-treatment (2c). A functional component 2d serves as a floor cover or lid 21. In an angular position—not shown—the floor cover lid is substantially plane with the standing area, reliably closing the opening 6.

The revolving device 11 has provided at the milking functional component 2b four teat cups 8 in a teat cup receiving device 9 which are manually connected with the teats 4 of the udder 3 of the animals. The revolving device 11 is provided, at the functional component 2a, with one or two foremilking cups 5, and the post-treatment component 2c is provided with one or two dipping cups 10. Also, clusters of four foremilking and/or dipping cups may be provided.

The functional components 2a, 2b and 2c or their respective treatment devices are transferable from the lower rest position 17 to the presentation position 16 by way of rotating the revolving device 11.

In FIG. 1 the functional component 2a is illustrated in the first pivoting position 26, in which it is in the active position, while the functional components 2b and 2c are disposed in an inactive position. By way of pivoting into the second pivoting position 27 illustrated in FIG. 2, the functional component 2b is transferred into the active position, while the functional component 2a is pivoted into an inactive position. FIG. 3 illustrates the third pivoting position 28 in which the functional component 2c is in the active position, while the functional components 2a and 2b are in inactive positions. A pivoting of the milking module causes the individual functional components to move inside the rotational circle 25.

In this example, three treatment devices are provided at the revolving device 11. It is also conceivable to dispose two treatment devices only on the revolving device 11. It is also conceivable to dispose four or more devices.

Due to the invention an operator will have better control when treating the animals. Moreover, milking will proceed more smoothly. Furthermore the farmer can better observe the health of udders and animals during milking which will be beneficial to the health of the herd.

When a new animal has entered the milking place 1 and has been properly positioned, the functional component 2a is firstly pivoted such that the cleaning and foremilking cup 5 exits through the elongated, narrow openings 6 in the standing area 7 to be pivoted into the presentation position 16.

The milker takes the cleaning cup 5 in the presentation position 16 in his hand and guides the cleaning and foremilking cup 5 to the udder 3 of the animal, cleans the teats 4 and draws the foremilk. Also, separate cleaning cups and foremilking cups may be provided which are fed one by one to the udder of the animal. Cleaning of the teats is preferably supported by ultrasound waves and a cleaning fluid which is sprayed on the teats from outside.

Thereafter the teat cups 8 are displaced into the presentation position 16 and the milker places the teat cups 8 on the teats 4 of the animal (FIG. 2).

The distance of the presentation position 16 from the edge of the milker pit depends on the animal and it may be as short as 5 cm, 10 cm or 15 cm. In this way, operation is considerably facilitated for the milker since the milker can grasp the teat cups from an ergonomically convenient position, employing minimal forces in lifting the teat cups.

The milking process is controlled by way of the milk flow. The milk flows through the short milk hose 13 and into the milk collection piece 14 and further through a rotating coupling 15 into the long milk hose 12. The milk flow may be determined for the entire milk flow or else individually for each teat. Near the end of the milking process, as the milk flow lessens, a stripping function may be activated. To this end, one pulls at the teat cups 8 from beneath, applying a downwardly force.

At the end of milking, the teat cups are automatically removed and displaced from the presentation position to return beneath the standing area 7, the so-called cow deck. The functional component 2c and a dipping cup 10 are displaced into the presentation position 16. Thereafter the teats can be dipped individually while concurrently the teat cups can already be rinsed or a cleaning be initiated. This can occur in the teat cup receiver 9 or in a separate CIP receiver (Clean In Place receiver) while the teat cup is being held e.g. in the teat cup receiver 9.

Spray nozzles may furthermore be provided to externally clean the milking module 2 and its functional components at periodic intervals so as to directly rinse off any dirt present.

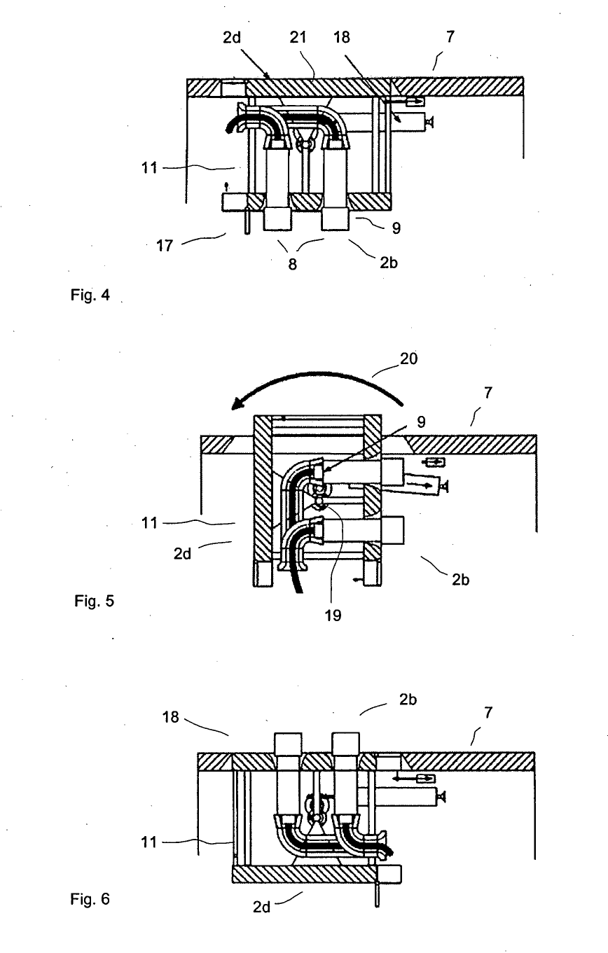

The embodiment illustrated in the FIGS. 4 to 6 illustrate another milking module 2 according to the invention. To facilitate readability, like or similar components are given the same reference numerals.

The milking module 2 according to FIG. 4 comprises only two functional components 2b and 2d. The functional component 2b configured as a milking functional component comprises four teat cups 8. The functional component 2d serves as a lid 21, a cover or a covering device, closing the opening provided in the milking parlor floor.

FIG. 4 illustrates the closed position which is assumed after each milking operation and at the end of milking. The flat cover plate facing upwardly may be used as a normal standing area of the milking parlor floor. The structure is configured such that the milking module will withstand the loads applied by the animals. In this position, the rest position 17, the teat cups are hanging with the openings facing downwardly. In this way particularly high safety from contamination is achieved.

FIG. 5 shows a snapshot of the milking module 2 in which the milking module is pivoted in the direction of the arrow 20 around the central hinge pin 19. The teat cups 8 are pivoted into the presentation position in which they protrude upwardly above the standing area 7.

In the illustration according to FIG. 6 the teat cups 8 have reached the presentation position and the milker can now manually place the teat cups on the teats 4.

After the end of a milking operation the functional component 2d configured as a cover lid is pivoted back to thus reliably close the opening provided in the standing area 7. A locking lever or the like may be provided to fixate the rotational position.

The drive for the pivoting movement of the revolving device or the milking module 2 may occur in all the cases by way of a cylinder 18 which may be configured as a vacuum or compressed air cylinder. It is also conceivable to employ an electric motor and/or a hydraulic motor. Drive may occur e.g. through a motor at the central hinge pin. An unintentional opening due to loads from above is not possible such that a high level of safety is provided.

The configuration according to the FIGS. 4 to 6 has the advantage that a rotational position of the milking module or the revolver will close the opening in the floor. This eliminates the need for separate closing components for the floor opening. The additional steps for incorporating the functional component 2d or the lid device are minor such that this configuration is very advantageous.

The functional component 2d or the lid device may comprise a perimeter padding to provide a cover suitable for animals. The functional component 2d may comprise one or two lid elements or lids 21. In the case of two lid elements, one element may be provided for the left, and one element for the right udder half.

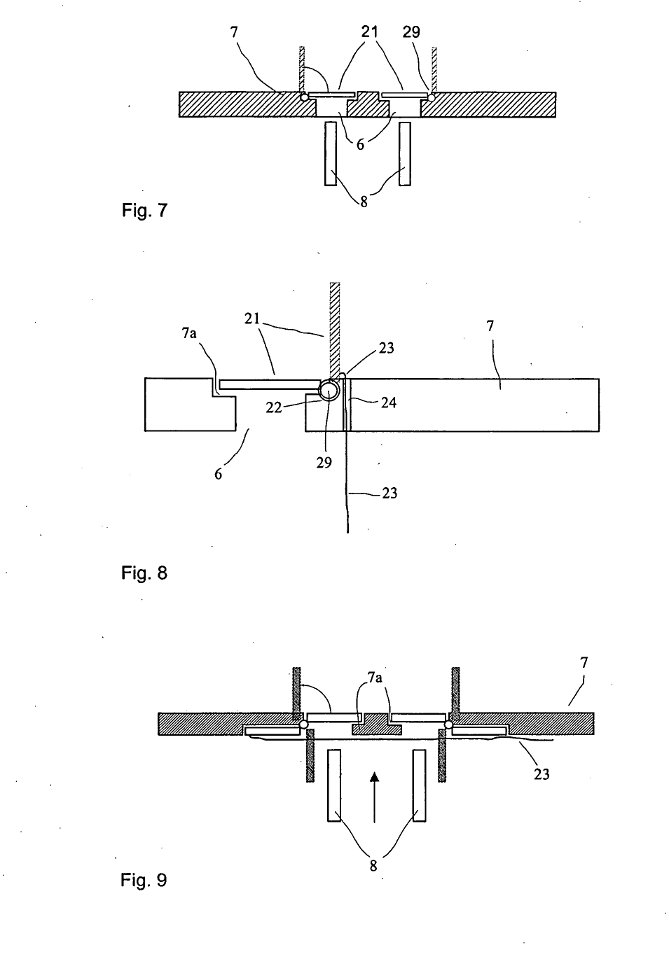

The FIGS. 7 to 9 illustrate possible configurations of covers or lids 21 for the floor opening 6 where the floor cover is not provided as a functional component 2d on the milking module.

In FIG. 7 the standing area comprises two elongated openings 6 which are in particular shaped as an oval. The longitudinal direction of the openings extends perpendicular to the illustration according to FIG. 7. The lids 21 are disposed to be pivotable about a horizontal hinge pin 29 which extends in particular in the longitudinal direction of the cow or of the milking place. In this way two teat cups 8 can be pivoted upwardly through one elongated opening 6 since the milking module is preferably pivotable about a hinge 29 positioned transverse to the longitudinal direction. The FIGS. 7 to 9 show the lids 21 in the dashed and hatched portions open, in solid lines, closed.

FIG. 8 illustrates a configuration with only one opening 6 provided which can be closed by means of a lid 21 which is likewise positioned to be pivotable about a horizontal hinge pin 29 which extends in particular in the transverse and longitudinal direction relative to the cow. Automatic opening of the lid 21 may be performed by a rope 23 provided to be passed through a guide or bore 24 in the milking parlor floor from beneath. As tension is applied to the rope 23 e.g. by a vacuum cylinder, the lid 21 opens, releasing the opening 6. To achieve automatic closing, a spring 22 may be provided to bias the lid 21 into the closed position.

When closed, the lid 21 is supported on a ledge 7a of the milking parlor floor 7. The ledge 7a may be a local part of the milking module 2.

FIG. 9 illustrates a modification of lids 21 extending centrosymmetrically to the hinge pin 29. Due to that part of the lids 21 is provided beneath the standing area 7, e.g. the rope 23 can be guided entirely beneath the milking parlor floor 7 as a protection from contamination. Also in this place a biasing of the lid into the closed position may be provided by means of a torsion spring 22.

1. A milking place in a dairy, the treatment station comprising: a standing area for an animal to be treated and at least one opening in the standing area through which at least one treatment device can be passed from beneath; a pivotable milking module; a hinge pin joined to the pivotable milking module; and a plurality of functional components joined to the hinge pin; wherein at least one functional component comprises a treatment device, automatically pivotable about the hinge pin of the milking module between a rest position disposed beneath the standing area and a presentation position disposed at least in part above the standing area.

2. The milking place according to claim 1, wherein the milking module moves into a first pivoting position and a first functional component moves into an active position in which a second functional component is in an inactive position, and wherein the milking module moves into a second pivoting position and the second functional component moves into an active position and the first functional component is in an inactive position.

3. The milking place according to claim 1, wherein milking module moves into the second pivoting position after moving out of the first pivoting position.

4. The milking place according to claim 2, wherein the milking module moves into a third pivoting position after moving out of the second pivoting position.

5. The milking place according to claim 1, wherein the treatment device can be grasped by an operator when in the presentation position.

6. The milking place according to claim 1, wherein at least one treatment device is taken from a group of treatment devices, consisting essentially of: teat cups, cleaning devices, foremilking cups, and teat care devices.

7. The milking place according to claim 1, wherein the pivotable milk module forms at least part of the standing area.

8. The milking place according to claim 1, wherein at least one treatment device comprises: a plurality of identical treatment units.

9. The milking place treatment station according to claim 1, and further comprising: functional components joined to the treatment devices.

10. The milking place according to claim 1, wherein the milking module revolves to substantially align a functional components with the presentation position.

11. The milking place according to claim 1, wherein a pivoting movement of the milking module moves different treatment devices into a base position.

12. The milking place according to claim 1, wherein an automatic movement of the milking module bring moves a treatment device between a base position the presentation position.

13. The milking place according to claim 1, wherein the milking module moves linearly between a rest and an operating position.

14. The milking place according to claim 1, and further comprising: a machine-stripping device for removing a teat cup from an animal.

15. The milking place according to claim 1, and further comprising: a rinsing adapter to rinse a treatment device.

16. The milking place according to claim 1, and further comprising: a rinsing device to rinse the milking module.

17. The milking place according to claim 1 and further comprising: a cover for the opening in the standing area.

18. The milking place according to claim 1, wherein the opening comprises at least two elongated openings in the standing area.

19. The milking place according to claim 1 and further comprising: a milk collection piece.

20. A milking module for treating animals comprising: a rotatable platform; a hinge pin disposed beneath a standing area of the treatment station; and a plurality of functional components, wherein at least one functional component is a treatment device for treating animals, and wherein the treatment device pivots automatically about the hinge pin between a rest position and a presentation position.

21. The milking module according to claim 20, wherein a number of different treatment devices are disposed on a milking module.

22. The milking module according to claim 20, wherein a functional component at least partially forms a standing area.

23. A method for treating animals and in particular for milking animals, comprising the steps of: positioning an animal on a standing area; passing a treatment device through an opening in the standing area from beneath, by pivoting a milking module having multiple functional components about a hinge pin disposed beneath a standing area; and automatically moving the treatment device from a rest position into a presentation position.

24. The method according to claim 23, and further comprising the step of: manually guiding the treatment device toward the udder of an animal to be treated.
